(19) United States
(12) Patent Application Publication
(10) Pub. No.: US 2024/0073601 A1
(43) Pub. Date: Feb. 29, 2024

(54) Computer Program Product and Effector

(71) Applicant: ZOOM CORPORATION, Tokyo (JP)

(72) Inventor: Shun Nakashima, Tokyo (JP)

(21) Appl. No.: 18/237,462

(22) Filed: Aug. 24, 2023

(30) Foreign Application Priority Data
Aug. 25, 2022 (JP) 2022-133773

(51) Int. Cl. H04R 3/04; H04R 1/02

(52) U.S. Cl. CPC H04R 3/04; H04R 1/02

(57) ABSTRACT

A computer program product for adding an acoustic characteristic of an object to an input digital signal. The computer program product causes a processor to execute process including a process S1 configured to detect an input level of the digital signal; processes S2 and S3 configured to determine respective mixing ratios of a plurality of impulse response (IR) data items by comparing the input level with at least one threshold; and processes S4 and S5 configured to convolve each of the plurality of IR data items with the digital signal in accordance with the mixing ratios determined in the process S3. Each of the plurality of IR data items is generated based on an impulse response measured by varying a level of an impulse input to the object.

### CROSS-REFERENCE TO RELATED APPLICATION

This application claims priority to Japanese Patent Application No. 2022-133773 filed Aug. 25, 2022, the disclosure of which is hereby incorporated by reference in its entirety.

### BACKGROUND OF THE INVENTION

### Field of the Invention

The present invention relates to a computer program product for adding an acoustic characteristic of an object to an input digital signal and an effector including the computer program product installed in a memory.

### Description of the Related Art

There is a conventionally known technique of digital effects for adding an acoustic characteristic of a specific speaker cabinet to the sound of a musical instrument, such as a guitar. For example, multi-effectors manufactured and sold by the present applicant under the trade name of “ZOOM® G3n Multi-Effects Processor” and the trade name of “ZOOM® G3Xn Multi-Effects Processor” are provided with a function of realistically reproducing the timbre of five kinds of speaker cabinet products below.

TABLE 1

| | Speaker Cabinets |
|---|---|
| 1 | Marchall 1960 A-type cabinet (4 × 12″ Celestion speakers) |
| 2 | Mesa Boogie Mark III cab (1 × 12″ Celestion Black Shadow speaker) |
| 3 | Fender ′65 Twin Reverb (2 × 12″ Jensen speakers) |
| 4 | Bogner Ecstasy cabinet (4 × 12″ Celestion speakers) |
| 5 | UK2 × 12 (2 × 12″ Celestion speakers) |

The acoustic characteristic of such a speaker cabinet is measured by an impulse response (IR). The impulse response is an output from an object with respect to an input impulse. For example, if the object is a speaker cabinet, an impulse signal is input to the speaker cabinet. The speaker cabinet then outputs sound in accordance with the impulse signal. The sound is picked up by a microphone and is thus converted to an electrical signal to obtain an IR data item representing the acoustic characteristic of the speaker cabinet. The digital signal processing convolves the input sound of a musical instrument with the IR data item to add the acoustic characteristic of the speaker cabinet to the output sound of the musical instrument. That is, the sound of the musical instrument has tone quality as if output from the specific speaker cabinet.

### PRIOR ART DOCUMENTS

### Patent Documents

Patent Document 1: U.S. Pat. No. 6,664,460
Patent Document 2: U.S. Pat. No. 7,026,539
Patent Document 3: U.S. Pat. No. 9,202,450

### SUMMARY OF THE INVENTION

### Technical Problem

Such an impulse response is measured by inputting an impulse at a fixed level to an object. The impulse response may thus be considered to measure and reproduce a static acoustic characteristic of an object. However, some of actual objects represent different acoustic characteristics in accordance with the volume of a sound source. For example, a speaker cabinet represents different acoustic characteristics between a small volume and a large volume of a musical instrument. An IR data item obtained by conventional impulse response measurement is thus not capable of dynamically changing the acoustic characteristic of a speaker cabinet in accordance with the volume of a musical instrument. Such an IR data item obtained by conventional impulse response measurement is capable of reproducing only one acoustic characteristic corresponding to one volume regardless of the volume of the musical instrument.

The present invention has been made in view of the above problems, and it is an object thereof to provide a computer program product capable of dynamically changing an acoustic characteristic of an object to be added to a digital signal in accordance with the input level of the digital signal and an effector including the computer program product installed in a memory.

### Solution to Problem

(1) To achieve the above objects, a computer program product of the present invention for adding an acoustic characteristic of at least one object to an input digital signal, the computer program product causes a processor to execute process including: a first process configured to detect an input level of the digital signal; a second process configured to determine respective mixing ratios of a plurality of impulse response (IR) data items by comparing the input level with at least one threshold; a third process configured to convolve each of the plurality of IR data items with the digital signal in accordance with the mixing ratios determined in the second process, wherein each of the plurality of IR data items is generated based on an impulse response measured by varying a level of an impulse input to the object.

(2) It is preferred that, in the computer program product of (1) above, the third process is configured to calculate a finite impulse response (FIR) coefficient obtained by mixing the respective IR data items and convolve the FIR coefficient with the digital signal in accordance with the mixing ratios determined in the second process.

(3) It is preferred that, in the computer program product of (1) or (2) above, each of the plurality of IR data items is generated based on an impulse response measured by varying the level of the impulse input to one of the objects.

(4) It is preferred that, in the computer program product of (1) or (2) above, each of the plurality of IR data items is generated based on an impulse response measured by varying the level of the impulse input to each of two or more of the objects.

(5) it is preferred that, in the computer program product of (3) above, the object is one speaker cabinet and each of the plurality of IR data items is generated based on an impulse response measured by varying a level of an impulse signal input to the speaker cabinet.

(6) It is preferred that, in the computer program product of (3) above, the object is one musical instrument and each of the plurality of IR data items is generated based on an impulse response measured by varying a level of an impulse signal input to the musical instrument.

(7) It is preferred that, in the computer program product of (3) above, the object is one space and each of the plurality of IR data items is generated based on an impulse response measured by varying a volume of sound originating from an impulse signal as a sound source and produced from a speaker placed in the space.

(8) It is preferred that, in the computer program product of (4) above, the object is two or more speaker cabinets and each of the plurality of IR data items is generated based on an impulse response measured by varying a level of an impulse signal input to each of the speaker cabinets.

(9) It is preferred that, in the computer program product of (4) above, the object is two or more musical instruments and each of the plurality of IR data items is generated based on an impulse response measured by varying a level of an impulse signal input to each of the musical instruments.

(10) It is preferred that, in the computer program product of (4) above, the object is two or more spaces and each of the plurality of IR data items is generated based on an impulse response measured by varying a volume of sound originating from an impulse signal as a sound source and produced from a speaker placed in each of the spaces.

(11) To achieve the above objects, an effector of the present invention includes the computer program product of (1) or (2) above, the computer program product being installed in a memory.

### Advantageous Effects of Invention

The computer program product and the effector of the present invention allow dynamic change of the acoustic characteristic of an object to be added to a digital signal in accordance with the input level of the digital signal.

### BRIEF DESCRIPTION OF THE DRAWINGS

FIG. 1 is a block diagram illustrating a device for measuring impulse responses according to an embodiment of the present invention.

FIG. 2 is a graph illustrating a waveform of a time stretched pulse (TSP) signal used for measurement of impulse responses.

FIG. 3 is a graph illustrating frequency characteristics of the TSP signal.

FIG. 4 is a graph illustrating a waveform of an impulse response IR1 when sound produced from a speaker cabinet is small in volume.

FIG. 5 is a graph illustrating a waveform of an impulse response IR2 when sound produced from the speaker cabinet is intermediate in volume.

FIG. 6 is a graph illustrating a waveform of an impulse response IR3 when sound produced from the speaker cabinet is large in volume.

FIG. 7 is a graph illustrating frequency characteristics of the impulse response IR1.

FIG. 8 is a graph illustrating frequency characteristics of the impulse response IR2.

FIG. 9 is a graph illustrating frequency characteristics of the impulse response IR3.

FIG. 10 is a block diagram illustrating an effector according to an embodiment of the present invention.

FIG. 11 is a flowchart illustrating processes S1 through S5 of a digital signal processor constituting the effector.

FIG. 12 is a schematic diagram to illustrate the processes S1 through S5 of the digital signal processor.

FIG. 13 is a circuit configuration diagram illustrating a finite impulse response (FIR) filter programmed to execute the process S5 of the digital signal processor.

FIG. 14 is a schematic diagram illustrating configuration of an IR data file used in the process S4 of the digital signal processor.

### DESCRIPTION OF THE INVENTION

Embodiments of a computer program product of the present invention and an effector including the computer program product installed in a memory are described below with reference to the drawings.

### 1. Term Definition

At first, the definition of the terms used herein is described. The term “object” includes movable properties and immovable properties representing an acoustic characteristic with respect to an input impulse. Examples of the movable properties as the “object” include items, such as a speaker cabinet, an amplifier, a musical instrument, a pickup, and a microphone. Examples of the immovable properties as the “object” include spaces, such as a concert hall, a recording studio, a stadium, and an outdoor stage. The term “impulse” widely includes sound sources input to the object, and examples thereof include: pulse signals; maximum-length linear shift register sequence (M-sequence) signals; impulse signals, such as a time stretched pulse (TSP) signal; and sound originating from an impulse signal as a sound source. The term “input” regarding impulses includes electrical input of an impulse signal and production of sound originating from an impulse signal as a sound source from a speaker. For example, the “input” when the object is an electrical device means electrical input of an impulse signal to the object. Meanwhile, the “input” when the object is a space means production of sound originating from an impulse signal as a sound source from a speaker. The term “level” regarding impulses includes a signal level of an impulse signal and a volume of sound originating from an impulse signal.

### 2. Measurement of Impulse Response

The computer program product in the present embodiment is characterized in that a digital signal processor is caused to execute a process configured to determine respective mixing ratios of a plurality of IR data items in accordance with the level of a digital signal input to an effector and a process configured to convolve each of the plurality of IR data items with the digital signal in accordance with the mixing ratios.

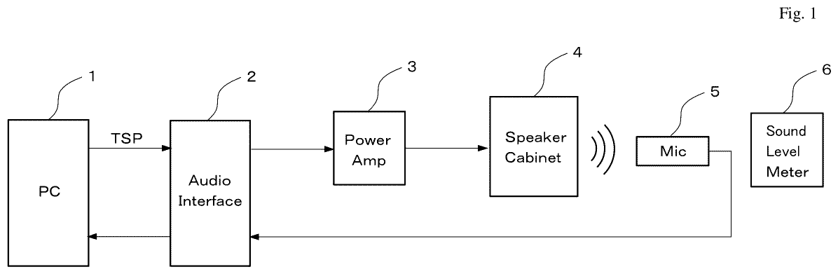

Each of the plurality of IR data items is generated based on an impulse response measured by varying a level of an impulse input to the object. FIG. 1 illustrates a device for measuring impulse responses of a specific speaker cabinet 4 as the object. This device is configured with a personal computer 1, an audio interface 2, a power amplifier 3, a microphone 5, and a sound level meter 6.

The personal computer 1 is electrically connected to the power amplifier 3 and the microphone 5 via the audio interface 2. The power amplifier 3 is electrically connected to the speaker cabinet 4 as the object. The microphone 5 is arranged to pick up sound produced from the speaker cabinet 4. The sound level meter 6 measures the volume of sound produced from the speaker cabinet 4.

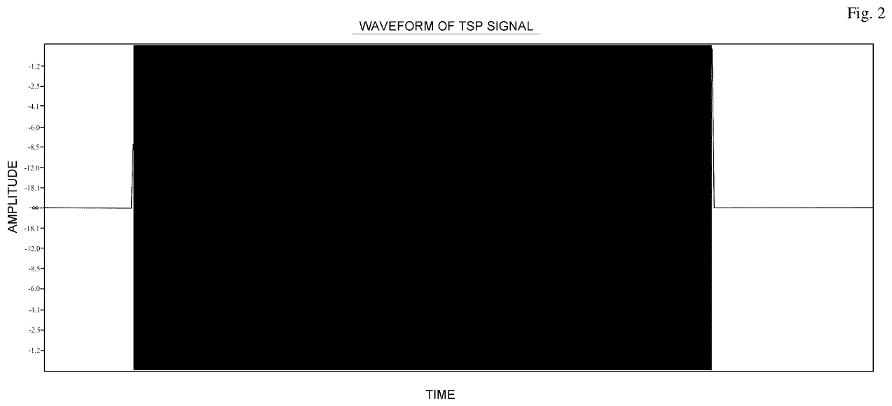

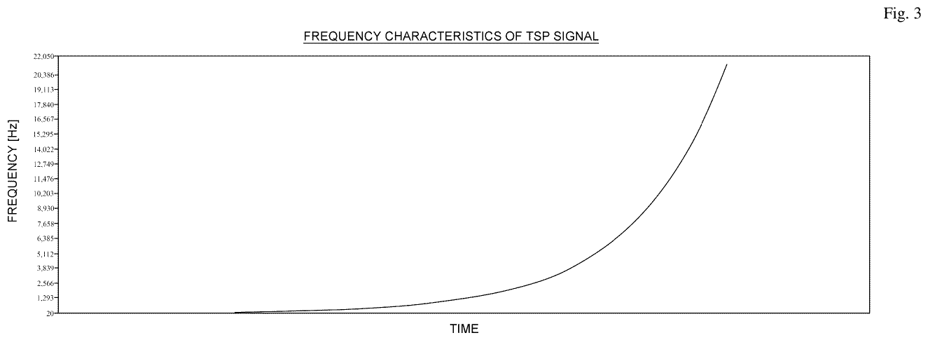

In the personal computer 1, an impulse response measurement program is installed. The impulse response measurement program causes the personal computer 1 to execute process, such as generation and output of an impulse and acquisition, saving, and analysis of an impulse response. In accordance with the impulse response measurement program, the personal computer 1 is capable of generating a plurality of kinds of impulse signal. Examples of the impulse signal generated by the personal computer 1 include an M-sequence signal and a TSP signal. In the present embodiment, a TSP signal illustrated in FIG. 2 is used to measure an impulse response of the speaker cabinet 4. The TSP signal is a signal obtained by continuously sweeping the sinusoidal frequency from a low value to a high value in a short time. FIG. 3 illustrates the frequency characteristics of the TSP signal in FIG. 2.

The TSP signal output from the personal computer 1 is input to the power amplifier 3 via the audio interface 2. The power amplifier 3 is configured to allow setting of an amplification factor. The power amplifier 3 amplifies the input TSP signal based on a preset amplification factor. Thus, sound in the volume in accordance with the signal level of the TSP signal is produced from the speaker cabinet 4. The sound is an impulse response of the speaker cabinet 4. The sound produced from the speaker cabinet 4, in other words, the impulse response of the speaker cabinet 4 is picked up by the microphone 5 and converted to an electrical signal. The impulse response converted to the electrical signal is acquired by the personal computer 1 via the audio interface 2.

In the present embodiment, the volume of the sound produced from the speaker cabinet 4 is varied at three stages of small, intermediate, and large to perform measurement three times for the impulse responses IR1, IR2, and IR3. The volume of the sound produced from the speaker cabinet 4 is measured by the sound level meter 6. The sound level meter 6 is placed in a position 1 m away from the speaker cabinet 4. In the three-time measurement of the impulse responses IR1, IR2, and IR3, the maximum value of the volume of the sound produced from the speaker cabinet 4 is designed to be the value in Table 2 below.

TABLE 2

Sound Volume

| | | |
|---|---|---|
| IR1 | Small | 75 dBspl ± 2 dB |
| IR2 | Intermediate | 90 dBspl ± 2 dB |
| IR3 | Large | 110 dBspl ± 2 dB |

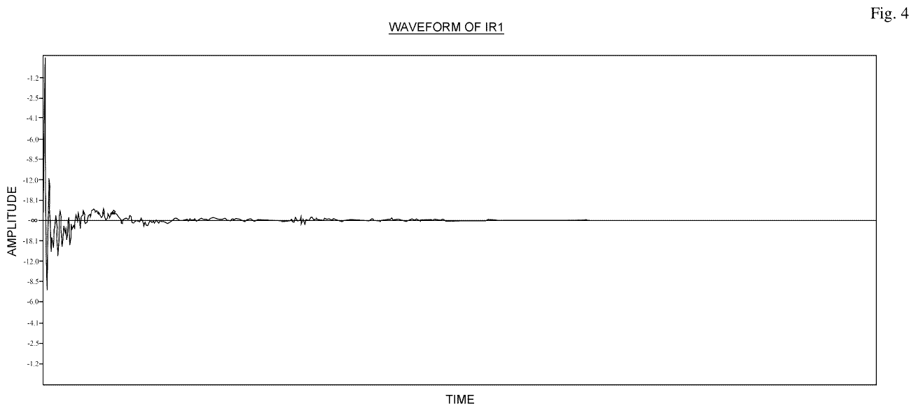

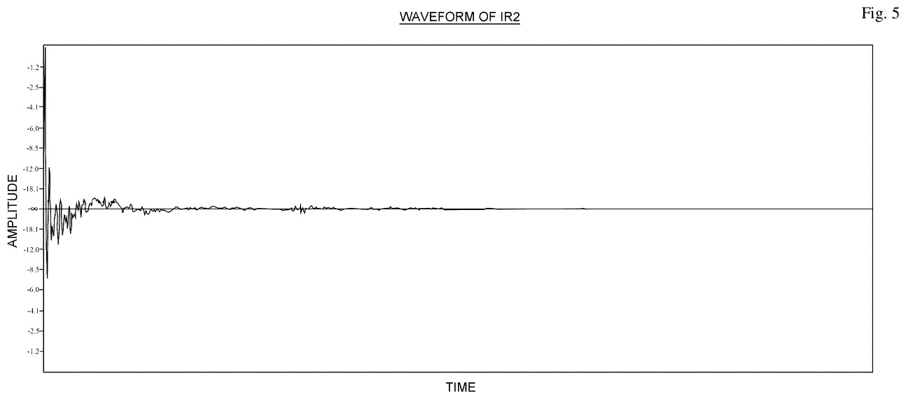

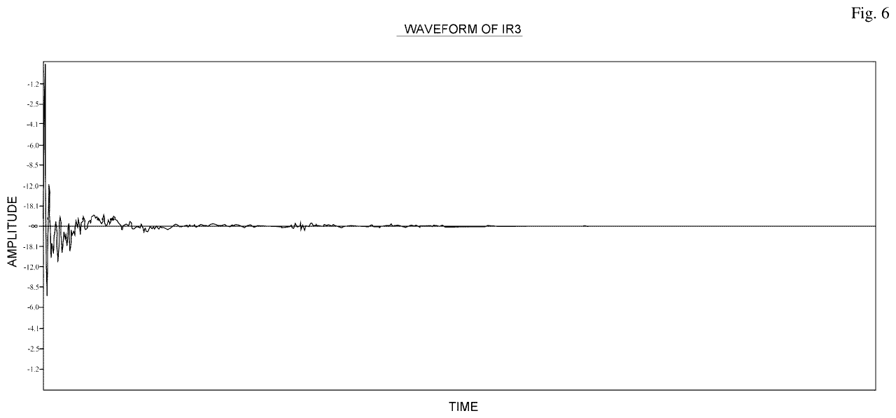

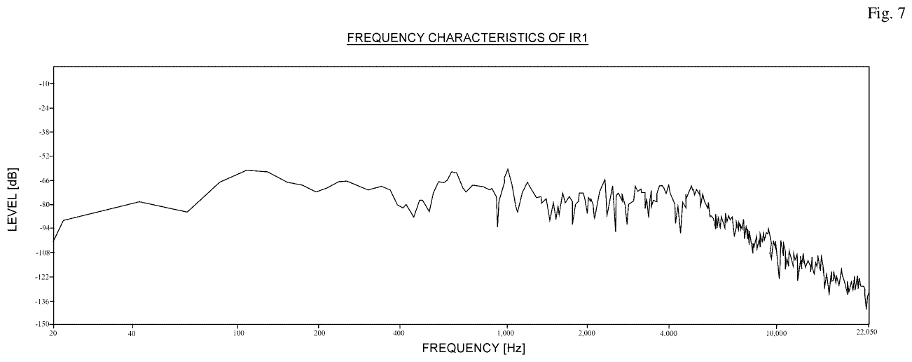

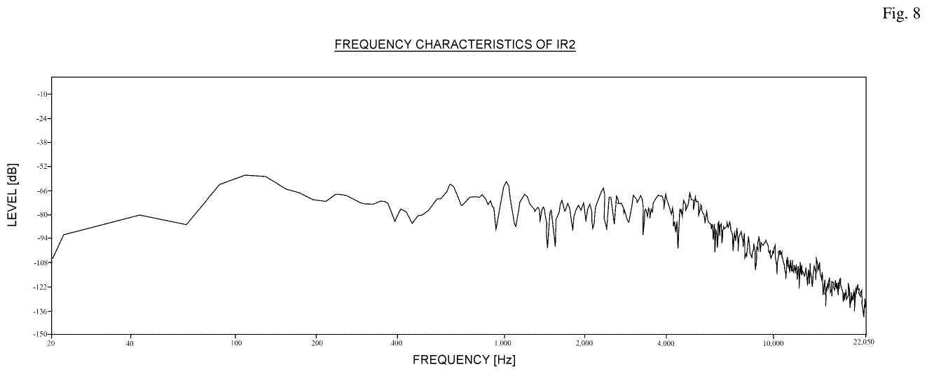

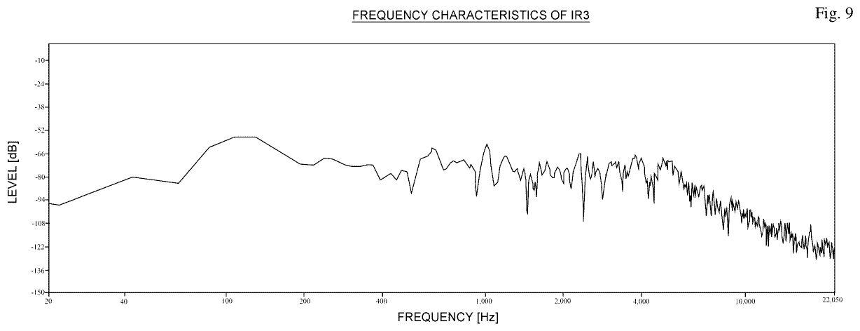

FIG. 4 illustrates the waveform of the impulse response IR1 when the sound produced from the speaker cabinet 4 is small in volume. FIG. 5 illustrates the waveform of the impulse response IR2 when the sound produced from the speaker cabinet 4 is intermediate in volume. FIG. 6 illustrates the waveform of the impulse response IR3 when the sound produced from the speaker cabinet 4 is large in volume. FIGS. 7, 8, and 9 illustrate the respective frequency characteristics of the impulse responses IR1, IR2, and IR3. The respective data items (IR data items) of the impulse responses IR1, IR2, and IR3 illustrated in FIGS. 4 through 6 are combined in one IR data file. This IR data file is used for the process of the processor in accordance with the computer program product in the present embodiment.

### 3. Effector

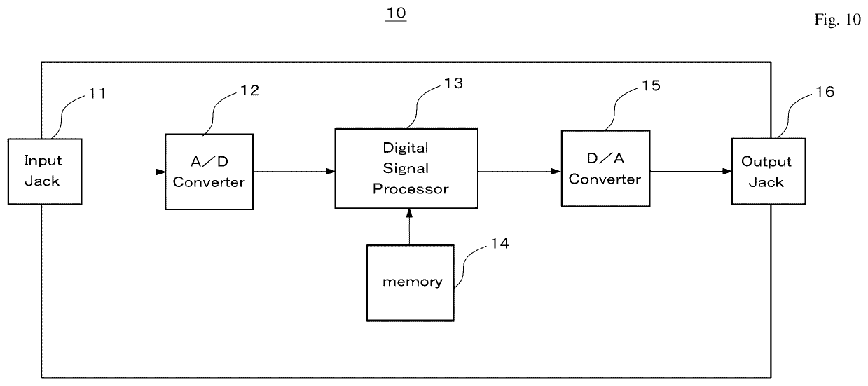

FIG. 10 illustrates the main configuration of an effector 10 according to the present embodiment. The effector 10 mainly includes an input jack 11, an A/D converter 12, a digital signal processor 13, a memory 14, a D/A converter 15, and an output jack 16. In the memory 14, the computer program product according to the present embodiment is installed.

The input jack 11 is electrically connected to a musical instrument, such as a guitar and a bass guitar, for example, via a shielded cable. An analog signal output from the musical instrument is input to the effector 10 via the input jack 11. The A/D converter 12 converts the analog signal input to the input jack 11 to a digital signal. The digital signal processor 13 executes process for adding the acoustic characteristic of the speaker cabinet 4 to the input digital signal in accordance with the computer program product of the present embodiment installed in the memory 14. The process of the digital signal processor 13 in accordance with the computer program product of the present embodiment is described later. The D/A converter 15 converts the digital signal processed by the digital signal processor 13 to an analog signal. The output jack 16 is electrically connected to an external device, such as another effector and another power amplifier, for example, via a shielded cable. The analog signal converted by the D/A converter 15 is output to the external device via the output jack 16.

### 4. Process of Digital Signal Processor

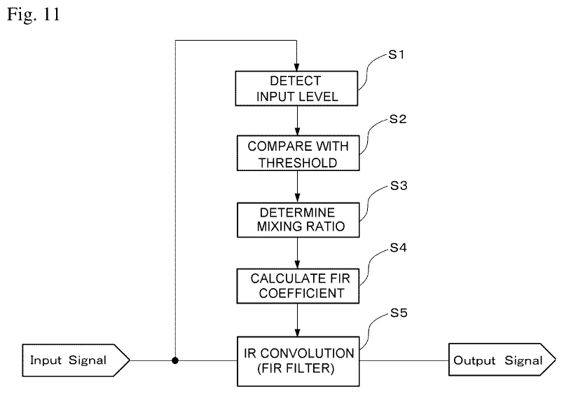

FIG. 11 illustrates a flow of the processes S1 through S5 of the digital signal processor 13 executed in accordance with the computer program product in the present embodiment. As described above, the digital signal converted by the A/D converter 12 is input to the digital signal processor 13. The processes S1 through S5 in FIG. 11 are repeated at intervals of, for example, 360 μs for delayed digital signals.

In the process S1 in FIG. 11, the digital signal processor 13 detects the input level of the digital signal.

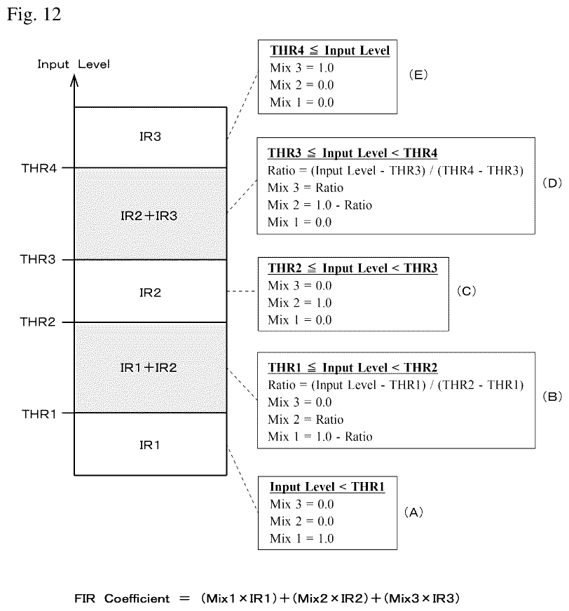

Then, the process goes on to S2 in FIG. 11 and the digital signal processor 13 compares the input level of the digital signal with four thresholds THR1, THR2, THR3, and THR4 illustrated in FIG. 12 in order. Then, the process goes on to S3 in FIG. 11 and the digital signal processor 13 determines mixing ratios Mix1, Mix2, and Mix3 of the respective IR data items of the impulse responses IR1, IR2, and IR3 described above based on the results of the comparison in the process 2.

As illustrated in (A) in FIG. 12, if the input level of the digital signal is determined to be less than the first threshold THR1, the digital signal processor 13 determines the mixing ratio Mix1 of the IR data item of the impulse response IR1 as “1.0”, the mixing ratio Mix2 of the IR data item of the impulse response IR2 as “0.0”, and the mixing ratio Mix3 of the IR data item of the impulse response IR3 as “0.0”. As a result, only the IR data item of the impulse response IR1 when the volume is small is applied to the input digital signal.

As illustrated in (B) in FIG. 12, if the input level of the digital signal is determined to be the first threshold THR1 or more and less than the second threshold THR2, the digital signal processor 13 determines the mixing ratio Mix1 of the IR data item of the impulse response IR1 as “1.0—Ratio”, the mixing ratio Mix2 of the IR data item of the impulse response IR2 as “Ratio”, and the mixing ratio Mix3 of the IR data item of the impulse response IR3 as “0.0”. The Ratio in this case is calculated by (Input Level−THR1)/(THR2−THR1). As a result, the IR data item of the impulse response IR1 when the volume is small and the IR data item of the impulse response IR2 when the volume is intermediate are applied to the input digital signal, at the mixing ratio in accordance with the input level.

As illustrated in (C) in FIG. 12, if the input level of the digital signal is determined to be the second threshold THR2 or more and less than the third threshold THR3, the digital signal processor 13 determines the mixing ratio Mix1 of the IR data item of the impulse response IR1 as “0.0”, the mixing ratio Mix2 of the IR data item of the impulse response IR2 as “1.0”, and the mixing ratio Mix3 of the IR data item of the impulse response IR3 as “0.0”. As a result, only the IR data item of the impulse response IR2 when the volume is intermediate is applied to the input digital signal.

As illustrated in (D) in FIG. 12, if the input level of the digital signal is determined to be the third threshold THR3 or more and less than the fourth threshold THR4, the digital signal processor 13 determines the mixing ratio Mix1 of the IR data item of the impulse response IR1 as “0.0”, the mixing ratio Mix2 of the IR data item of the impulse response IR2 as “1.0—Ratio”, and the mixing ratio Mix3 of the IR data item of the impulse response IR3 as “Ratio”. The Ratio in this case is calculated by (Input Level−THR3)/(THR4−THR3). As a result, the IR data item of the impulse response IR2 when the volume is intermediate and the IR data item of the impulse response IR3 when the volume is large are applied to the input digital signal, at the mixing ratio in accordance with the input level.

As illustrated in (E) in FIG. 12, if the input level of the digital signal is determined to be the fourth threshold THR4 or more, the digital signal processor 13 determines the mixing ratio Mix1 of the IR data item of the impulse response IR1 as “0.0”, the mixing ratio Mix2 of the IR data item of the impulse response IR2 as “0.0”, and the mixing ratio Mix3 of the IR data item of the impulse response IR3 as “1.0”. As a result, only the IR data item of the impulse response IR3 is applied to the input digital signal.

Then, the process goes on to S4 in FIG. 11 and the digital signal processor 13 calculates a finite impulse response (FIR) coefficient. The FIR coefficient is calculated by (Mix1×IR1)+(Mix2×IR2)+(Mix3×IR3). As understood from this numerical formula, the FIR coefficient is obtained by mixing the respective IR data items of the three impulse responses IR1, IR2, and IR3 in accordance with the mixing ratios Mix1, Mix2, and Mix3 determined in the process S3.

Then, the process goes on to S5 in FIG. 11 and the digital signal processor 13 convolves the FIR coefficient calculated in the process S4 with the input digital signal. The convolution of an input signal x and an impulse response h at a time instant n of the discrete time is generally expressed by a numerical formula (1) below.

$$\begin{matrix}[ Math 1 ] & \\ h [ n ] * x [ n ] = {\sum }_{m = 0}^{M} h [ m ] x [ n - m ] & ( 1 )\end{matrix}$$

It should be noted that M is the length (number of samples) of the impulse response.

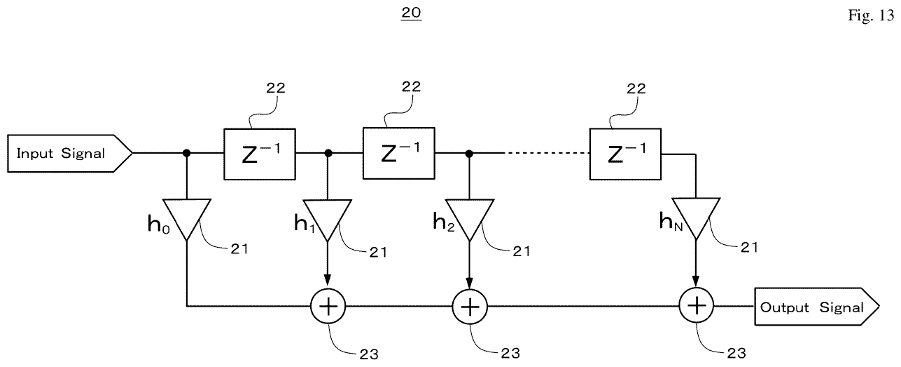

The convolution of the FIR coefficient in the process S5 in FIG. 11 is performed by an FIR filter 20 illustrated in FIG. 13. The FIR filter 20 is configured with multipliers 21, delayers 22, and adders 23. In FIG. 13, hₙ is a filter coefficient. In FIG. 13, N is the degree of the filter. The FIR coefficient calculated in the process S4 in FIG. 11 is used as the filter coefficient hₙ in FIG. 13. Such an FIR filter 20 convolves the FIR coefficient in accordance with the input level of the input digital signal with the digital signal. That is, the respective IR data items of the three impulse responses IR1, IR2, and IR3 are convolved with the digital signal in accordance with the mixing ratio depending on the input level. As a result, it is possible to dynamically change the acoustic characteristic of the speaker cabinet 4 to be added to the digital signal in accordance with the input level of the digital signal.

### 5. IR Data File

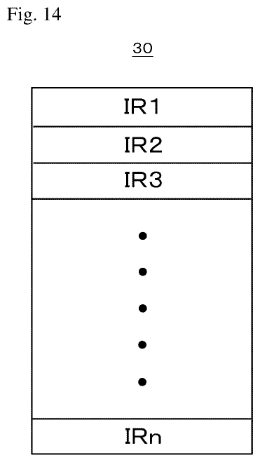

In the process S4 in FIG. 11, the digital signal processor 13 refers to an IR data file 30 illustrated in FIG. 14 to calculate the FIR coefficient. The IR data file 30 has a data structure where each IR data item of the impulse responses IR1, IR2, and IR3 illustrated in FIGS. 4 through 6 are combined into one. The digital signal processor 13 reads each IR data item of the impulse responses IR1, IR2, and IR3 from the IR data file 30 to calculate the FIR coefficient.

Although the computer program product in the present embodiment uses the IR data items of the three impulse responses IR1, IR2, and IR3 when the volume is small, intermediate, and large, the number of IR data items is not particularly limited. For example, the volume of sound produced from the speaker cabinet 4 is divided into four or more stages to obtain each IR data item of four or more impulse responses IR1 through IRn. The respective IR data items of these impulse responses IR1 through IRn may be combined in the one IR data file 30. The respective IR data items of the impulse responses IR1 through IRn constituting the IR data file 30 are preferably combined in order from the impulse response IR1 of the sound, smallest in volume, produced from the speaker cabinet 4 to the impulse response IRn of the sound largest in volume.

### 6. Others

The computer program product and the effector of the present invention are not limited to the embodiments described above. For example, the object for measuring impulse responses is not limited to the speaker cabinet 4. Such an object includes movable properties and immovable properties representing an acoustic characteristic with respect to an input impulse. For example, if the object is a space, such as a concert hall, a monitor speaker is used instead of the speaker cabinet 4 illustrated in FIG. 1. The speaker cabinet 4 illustrated in FIG. 1 has a distinctive acoustic characteristic as the speaker cabinet products listed in Table 1. In contrast, monitor speakers do not have a distinctive acoustic characteristic to reproduce the original sound with high fidelity. Production of sound originating from an impulse signal as a sound source from such a monitor speaker to a space as the object allows measurement of an impulse response of this space. Data of the impulse responses of a space is used for, for example, reproducing reverberations of a specific concert hall.

The object to measure impulse responses is not limited to one. A plurality of IR data items may be generated based on an impulse response measured by varying the level of an impulse input to two or more objects. Examples of the two or more objects include the five kinds of speaker cabinet products listed in Table 1. The level of an impulse input to the respective five kinds of speaker cabinet products is varied at five stages to perform measurement five times for impulse responses IR1 through IR5. The data items of the impulse responses IR1 through IR5 represent the respective acoustic characteristics of the five kinds of speaker cabinet products. The IR data items of the impulse responses IR1 through IR5 is applied to the digital signal in accordance with the input level of the digital signal. In other words, the different acoustic characteristics of the speaker cabinet products are added to the digital signal in accordance with the input level of the digital signal.

### REFERENCE SIGNS LIST

1 Personal Computer
2 Audio Interface
3 Power Amplifier
4 Speaker Cabinet
5 Microphone
6 Sound Level Meter
10 Effector
11 Input Jack
12 A/D Converter
13 Digital Signal Processor (DSP)
14 Memory
15 D/A Converter
16 Output Jack
20 FIR Filter
21 Multiplier
22 Delay Line
23 Adder
30 IR Data File

What is claimed is:

1. A computer program product for adding an acoustic characteristic of at least one object to an input digital signal, the computer program product causing a processor to execute process comprising:
a first process configured to detect an input level of the digital signal;
a second process configured to determine respective mixing ratios of a plurality of impulse response (IR) data items by comparing the input level with at least one threshold;
a third process configured to convolve each of the plurality of IR data items with the digital signal in accordance with the mixing ratios determined in the second process, wherein
each of the plurality of IR data items is generated based on an impulse response measured by varying a level of an impulse input to the object.

2. The computer program product according to claim 1, wherein the third process is configured to calculate a finite impulse response (FIR) coefficient obtained by mixing the respective IR data items and convolve the FIR coefficient with the digital signal in accordance with the mixing ratios determined in the second process.

3. The computer program product according to claim 1 or 2, wherein each of the plurality of IR data items is generated based on an impulse response measured by varying the level of the impulse input to one of the objects.

4. The computer program product according to claim 1 or 2, wherein each of the plurality of IR data items is generated based on an impulse response measured by varying the level of the impulse input to each of two or more of the objects.

5. The computer program product according to claim 3, wherein the object is one speaker cabinet and each of the plurality of IR data items is generated based on an impulse response measured by varying a level of an impulse signal input to the speaker cabinet.

6. The computer program product according to claim 3, wherein the object is one musical instrument and each of the plurality of IR data items is generated based on an impulse response measured by varying a level of an impulse signal input to the musical instrument.

7. The computer program product according to claim 3, wherein the object is one space and each of the plurality of IR data items is generated based on an impulse response measured by varying a volume of sound originating from an impulse signal as a sound source and produced from a speaker placed in the space.

8. The computer program product according to claim 4, wherein the object is two or more speaker cabinets and each of the plurality of IR data items is generated based on an impulse response measured by varying a level of an impulse signal input to each of the speaker cabinets.

9. The computer program product according to claim 4, wherein the object is two or more musical instruments and each of the plurality of IR data items is generated based on an impulse response measured by varying a level of an impulse signal input to each of the musical instruments.

10. The computer program product according to claim 4, wherein the object is two or more spaces and each of the plurality of IR data items is generated based on an impulse response measured by varying a volume of sound originating from an impulse signal as a sound source and produced from a speaker placed in each of the spaces.

11. An effector, comprising a memory, wherein the computer program product according to claim 1 or 2 is installed in the memory.
